(19) United States
(12) Patent Application Publication
(10) Pub. No.: US 2014/0309146 A1
(43) Pub. Date: Oct. 16, 2014

(54) Emulsions and methods usable within a wellbore

(71) Applicants: Orlando D'Elia, Wharton, TX (US); Fernando J. Guzman, Wharton, TX (US)

(72) Inventors: Orlando D'Elia, Wharton, TX (US); Fernando J. Guzman, Wharton, TX (US)

(73) Assignee: Prime Eco Research and Development, LLC

(21) Appl. No.: 13/986,235

(22) Filed: Apr. 15, 2013

(51) Int. Cl. C09K 8/34

(52) U.S. Cl. CPC C09K 8/34
USPC 507/129

(57) ABSTRACT

Emulsions usable within a wellbore as drilling fluids can be prepared by providing an emulsion base that includes a crude biodiesel product, and adding an emulsifying subsystem to the emulsion base. Solid particles in the emulsifying subsystem migrate to interfaces between continuous and discontinuous components in the emulsion base to define phases of the emulsion. A weighting agent can be added, as needed, to provide the emulsion with a suitable mud weight for use in a particular wellbore. Usable crude biodiesel products can include the unmodified product of a transesterification reaction, that include a continuous ester phase and a discontinuous alcohol phase without requiring separation or modification. Usable emulsifying subsystems can be prepared in situ. Use of esters, clays, and/or alcohols can enable reduction or elimination of water, brine, and petrochemicals in the emulsions.

### CROSS-REFERENCE TO RELATED APPLICATIONS

The present application claims priority to the United States Provisional application having the Ser. No. 61/797,687, filed Dec. 13, 2012, the entirety of which is incorporated by reference herein.

### FIELD

Embodiments usable within the scope of the present disclosure relate, generally, to compositions (e.g., emulsions) usable within a wellbore (e.g., as a drilling mud) and methods for forming such compositions, and more specifically, to invert emulsions able to be efficiently produced from readily available waste/byproducts (e.g., crude biodiesel products) having a reduced environmental impact.

### BACKGROUND

When drilling a well (e.g., to recover hydrocarbons from the earth), the conventional practice is to rotate a drill bit using a string of attached tubular segments (e.g. drill pipe or casing) to form and extend a bore within the earth. To facilitate this process, a fluid, known as “drilling mud,” must be provided into the wellbore. Drilling mud cools and lubricates the drilling string and drill bit, counteracting much of the heat produced by friction during drilling operations and forming a barrier or cushion (e.g., a “filter cake”) between the walls of the wellbore and the drilling string, while also carrying debris formed by drilling (e.g., “cuttings”) away from the base of the wellbore to the surface. The type and characteristics of the drilling mud (e.g., viscosity, weight, etc.) used for a particular drilling operation can vary depending on the characteristics of the formation where the drilling operation is taking place (e.g., temperature, depth, wellbore stability, formation of gas hydrates, shale dispersion, etc.). Use of a suitable drilling mud can improve the rate of penetration of the drill bit and reduce or eliminate many difficulties inherent in the drilling process.

As such, the use of drilling muds having appropriate characteristics that correspond to a formation is of paramount importance. For example, in cases where the hydrostatic fluid pressure of the drilling mud exceeds the permeable pressure of an exposed region of a formation, the drilling mud may have a tendency to flow into the formation, which can cause the drilling string to be urged into contact with the borehole wall at points where drilling mud pressure exceeds that of the formation. A sufficiently large contact area between a drill string and the borehole wall can prevent further rotation, raising, and/or lowering of the drilling string. In formations containing shale, use of a drilling mud containing a significant quantity of water can cause the water or water-based fluid to hydrate, swell, and/or otherwise be dispersed into the wellbore formation, potentially damaging the formation and/or wellbore.

In harder formations, a drilling mud that forms a somewhat permeable filter cake between the borehole wall and drilling string may be acceptable, or even desirable, as the accumulation of a thick and/or impermeable filter cake could otherwise create obstructed regions in the wellbore that may cause the drilling string to stick, increase drag and pressure surges, and hinder evaluation of the formation. In other types of formations, a permeable filter cake can lead to fluid loss, which can damage the formation, as well as hinder evaluation thereof.

Some types of existing drilling muds include oil-in-water emulsions (an emulsion that includes water or a similar aqueous medium as a continuous phase, within which droplets of an organic compound are suspended as a discontinuous oil phase). Such emulsions normally include water, oil, emulsifiers (primary and secondary, wetting agents/surfactants, etc.), clays or polymers, various treating agents that control the physical, chemical, and/or rheological properties of the emulsion, and a weighting agent (e.g., barite, hematite, etc.) to provide the emulsion with a suitable weight for use as a drilling mud in a desired wellbore. Invert emulsions (water-in-oil emulsions, having a continuous oil phase within which discontinuous water/aqueous droplets are suspended) have also been found suitable for certain wellbore conditions, and in many cases have exhibited superior results when compared to water-based emulsions; however, use of the significant quantities of crude oil, diesel, kerosene, and mineral oils often present in invert emulsions can create an extremely negative environmental impact, and in some cases, may be hazardous for transport and handling. While efforts have been made to produce water-in-oil emulsions that minimize the quantity of aromatics present (e.g., through use of vegetable oils in place of mineral oils), such emulsions still present a significant negative environmental impact (e.g., loss of marine life), and are often less effective than emulsions containing a larger quantity of aromatics.

Ester-based drilling fluids (e.g., emulsions that include an ester as either the continuous or discontinuous phase) have shown suitable rheological characteristics and lubricities for use in wellbores, the properties of such drilling fluids being variable through selection of esters having a molecular structure that provides desired properties. The large majority of esters are non-toxic, biodegrade at a rate that complies with various environmental regulations and standards, contain no carcinogenic aromatics, contain little or no sulfur, and can be derived from non-petrochemical sources (e.g., animal and plant oils/fats). Similarly, polyalphaolefins (a class of synthetic oils) have shown suitable fluid properties while complying with environmental criteria with regard to biodegradation and environmental impact.

Independent of the chemicals used in the continuous oil phase of an invert (water-in-oil) emulsion, conventional practice includes the dissolution of calcium chloride or a similar salt (e.g., sodium chloride, potassium chloride, magnesium sulfate) into the water phase of the emulsion to promote wellbore stability. The osmotic force of dispersed brine within the emulsion pulls fluid from the formation (typically shales or clays), which dehydrates, consolidates, and stabilizes the formation. Use of high concentrations of salts, however, gives rise to disposal issues, as the salts do not undergo biodegradation, which in many cases, can cause the brine used in a drilling fluid to generate a more significant negative environmental impact than many hydrocarbon components of drilling fluids. As an alternative to brine, electrolytes have been used, though such salts are often cost-prohibitive and still generate similar concerns regarding disposal.

Alcohols (e.g., glycerols, polyglycerols, cyclicetherpolyols) can be used as alternatives to brine solutions due to the fact that the presence of alcohol, in place of water, eliminates the potential for hydration of shales by the drilling fluid. Alcohols can still interact with clay within formations, but the swelling is considerably less than that observed when clay contacts a water-based drilling fluid. However, invert emulsions that include alcohol as the discontinuous phase tend to be less stable at high temperatures, which are commonly encountered in formations during drilling operations. Even when heat-tolerant alcohols are used, barite settling and an undesirably high filtrate rate, indicating emulsion instability, are observed.

Independent of the chemicals used in the continuous or discontinuous phases of an emulsion, conventional emulsions require use of emulsifiers to prevent separation of the phases (e.g., caused by settling and aggregation of droplets of the discontinuous phase over time). Emulsifiers have an amphiphilic molecular structure (e.g., having a polar/hydrophilic end and a nonpolar/lipophilic end, spatially separated from one another). Such emulsifiers act at the interface between the continuous and discontinuous phases of an emulsion and lower the interfacial tension. Specifically, at the boundary between phases (e.g., about the edges of droplets of the discontinuous phase), emulsifiers form interfacial films, which prevent coalescence of droplets of the discontinuous phase. Emulsifiers can include nonionic substances (e.g., soap) or ionic (cationic or anionic) compounds (e.g., quaternary ammonium compounds). For example, the hydrophilic molecular moiety of nonionic emulsifiers can include glycerol, polyglycerol, sorbitans, carbohydrates, and/or polyoxyethylene gloycols, and can be linked to a lipophilic molecular moiety via ester and/or ether bonds. The lipophilic molecular moiety of such emulsifiers can include fatty alcohols, fatty acids, and/or iso-fatty acids. By varying the structure and size of the hydrophilic and lipophilic moieties, the properties of the emulsifier can be varied within wide limits. Selection of an emulsifier suited to the components of an emulsion and the conditions within which the emulsion will be used is of significant importance.

A reduction in the amount of emulsifier necessary to stabilize an emulsion can be achieved through the addition of finely divided solid particles, which accumulate at the phase boundary. For example, “Pickering” emulsions were discovered in the early 1900s, through the preparation of paraffin/water emulsions that were stabilized by the addition of various solids, such as basic copper sulfate, basic iron sulfate, or other metal sulfates. The solid particles serve as a mechanical barrier against coalescence of droplets of the discontinuous phase, by becoming irreversibly anchored at this interface, where they develop strong lateral interactions. In some emulsions, it is possible to wholly replace conventional emulsifiers (e.g., organic surfactants) with solid particles.

As such, preparation of a conventional emulsion can involve selection, acquisition, preparation, and mixing of a large number of components, from among a large number of alternatives, which can create inefficiencies with regard to cost and availability of materials, and the time required to prepare a suitable emulsion. First, an external phase of the emulsion must be selected and acquired. Within the external phase, both primary and secondary emulsifier agents must be added and dispersed. Appropriate wetting agents (and/or any other surfactants, rheology-modifying agents, or similar compounds) are then added, followed by lime or a similar component (typically to maintain reserve alkalinity). Only after each of these components has been added and dispersed can the internal phase of the emulsion finally be added to the external phase and mixed. After the addition of the internal phase, an organophilic clay or similar component is added, followed by a filtrate control additive, then a weighting agent. As such, preparation of an emulsion can require the selection and acquisition of multiple costly components, and at least eight separate steps.

A need exists for environmentally friendly emulsions, usable as drilling mud, that include no harmful, toxic, or carcinogenic organic components, while retaining the stability and effectiveness of conventional emulsions, including stability at wellbore temperatures and conditions.

A need also exists for emulsions that include no brine or similar environmentally harmful and/or non-biodegradable components.

Additionally, a need exists for emulsion systems that do not contain water, or contain a reduced amount of water when compared with conventional emulsions, thereby reducing or eliminating the potential for water-based damage to wellbore formations.

A further need exists for emulsions that can be produced efficiently and inexpensively, using readily available components while requiring a comparatively small number of steps to prepare such emulsions.

Embodiments usable within the scope of the present disclosure meet these needs.

### SUMMARY

Embodiments usable within the scope of the present disclosure include emulsions usable within a wellbore (e.g., as drilling mud and/or other fluids) and methods for producing and/or preparing such emulsions. An embodied emulsion can be prepared, generally, by providing an emulsion base that includes a crude biodiesel product, the crude biodiesel product having a continuous component and a discontinuous component, and adding an emulsifying subsystem that includes solid particles to the emulsion base, such that the solid particles migrate to interfaces between the continuous and discontinuous components, thereby resisting separation of the continuous and discontinuous components and defining a continuous and discontinuous phase within the emulsion. In embodiments where the emulsion is to be used as a drilling mud and/or other components where a specific weight, density, and/or specific gravity of the emulsion is desirable, a weighting agent (e.g., barite, hematite, and/or other weighting agents) can be added to the emulsion base for providing the emulsion with a weight and/or specific gravity adapted for use as a drilling mud within a desired wellbore.

The production of biodiesel products can include the trans-esterification of an oil (e.g., soybean oil, another vegetable oil, an animal oil, or any other oil or fat) with an alcohol (e.g., a low molecular weight alcohol), typically using alkaline catalysts. However, prior to obtaining a useful end product, the resulting crude biodiesel product obtained through the trans-esterification reaction must normally be subjected to further separation and/or refining operations to separate esters and other components from water, glycerin, fiber, and other materials produced during the trans-esterification process and/or by-products remaining after the trans-esterification reaction. Embodiments usable within the scope of the present disclosure can include use of a substantially unmodified (e.g., unseparated and/or unrefined) crude biodiesel product as an emulsion base. As such, a substantially unmodified compound produced through the trans-esterification of an oil (e.g., soybean oil or another vegetable oil) with an alcohol (e.g., a low molecular weight alcohol, such as 2-ethyl hexanol, methanol, ethanol, etc.), using alkaline catalysts, can contain a continuous and discontinuous component usable for forming embodiments of the present emulsion, without requiring substantive modification, separation, and/or refinement. In an embodiment, the continuous component can include an ester (e.g., an alkyl ester), and the discontinuous component can include glycerin, a polyglycerin derivative, or combinations thereof.

In an embodiment, the emulsifying subsystem can be formed by adding an unmodified phyllosilicate (e.g., a smectite clay, such as bentonite, hectorite, bidellite, stevensite, and/or saponite) and a quaternary ammonium compound (e.g., quaternium-18) or similar interactive component to the emulsion base. The phyllosilicate and quaternary ammonium compound can thereby interact in situ to form an organophilic component. It should be understood, however, that in other embodiments, an organophilic component could be directly added to the emulsion base, and depending on the desired characteristics of the emulsion, other types of subsystems having solid particles that tend to migrate to the interfaces between the continuous and discontinuous components of the emulsion base can be used without departing from the scope of the present disclosure. In a further embodiment, the unmodified phyllosilicate can include a smectite clay having a cation exchange capacity of 75 milliequivalents per 100 grams of smectite clay, or greater. Embodied emulsions can include, by way of example, 20-40 pounds per barrel (e.g., 30 pounds per barrel) of the emulsifying subsystem. Additionally, embodiments can include the addition of iron oxide (e.g., mixed iron oxides), magnesium silicate (talc), one or more types of metal oxide, and/or similar inorganic, amphiphilic components to the emulsifying subsystem.

While embodied emulsions can exhibit stability at high temperatures (e.g., temperature ranges normally encountered within a wellbore), in an embodiment, a rheology modifier that includes an organic derivative of a clay (e.g., Bentone® 38) can be added to the emulsion base to further promote stability at high temperatures.

### DETAILED DESCRIPTION OF THE EMBODIMENTS

Before explaining the present embodiments in detail, it is to be understood that the embodiments are not limited to the particular descriptions and that the embodiments can be practiced or carried out in various ways.

Embodiments usable within the scope of the present disclosure include invert (e.g., water-in-oil) emulsions usable within a wellbore environment (e.g., as a drilling mud or other wellbore fluid), that can exhibit an effectiveness greater than or equal to conventional alternatives, while minimizing environmental impact, incorporating readily available components, and enabling an extremely efficient method of production and/or preparation. As described previously, the preparation of conventional emulsions can require numerous steps (e.g., eight or more steps). For example, to the external/continuous phase of a desired emulsion, both primary and secondary emulsifying agents must be added, followed by wetting agents, then followed by lime. To this prepared mixture of external phase and emulsifiers, the internal/discontinuous phase of the emulsion can be added, after which an organophilic clay or similar component, a filtrate control additive, and a weighting agent (e.g., when intending to use an emulsion as a drilling mud) can be added.

Embodiments usable within the scope of the present disclosure can be produced, generally, through a minimum of steps: the provision of an emulsion base, the addition/dispersion of an emulsifying subsystem within the base, and if the emulsion is to be used as a drilling mud, the addition of sufficient weighting material to provide the emulsion with a desired mud weight. In a specific embodiment, the emulsion base can include a crude biodiesel product.

Biodiesel materials, such as methyl esters of fatty acids derived from vegetable or animal fats, are conventionally manufactured by freeing fatty acids from glycerol (e.g., via a trans-esterification process). Exemplary methods are described in U.S. Pat. Nos. 6,399,800; 6,348,074; 6,015,444; 6,203,585; 6,174,501; 6,235,104; and 7,270,768, each of which are incorporated herein by reference in their entirety. In a typical mechanism, an animal or plant fat and/or oil (composed of triglycerides—esters that contain both fatty acids and glycerol) is reacted with an alcohol, such as ethanol or methanol. A base can be used to deprotonate the alcohol to speed the reaction, while heat and catalysts (e.g., alkaline catalysts—typically strong bases, such as sodium or potassium hydroxide) can be used to speed the reaction. Because the trans-esterification reaction is an equilibrium reaction, the reaction is often incomplete, and yields of biodiesel products can vary significantly (e.g., 40-90 percent) depending on the reactants, catalysts, temperature and pressure conditions, and the amount of time permitted to pass. Through the trans-esterification reaction, the organic group of the ester is exchanged for that of the alcohol, which, in the case of triglycerides, results in the formation of alkyl ester and crude glycerol. As such, in the production of biodiesel, significant amounts of a waste stream, that can include glycerin, water, salts of fatty acids and/or free fatty acids, methanol, free glycerol, soap, unconverted monoglycerides and diglycerides, and/or other polar compounds, is produced, requiring additional separation/processing steps to obtain usable biodiesel products, while also creating disposal issues with regard to the waste stream. As defined herein, the term “crude biodiesel product” includes the immediate product of a trans-esterification reaction (e.g., a product that has not been subjected to substantial modification and/or separation processes).

Prior to obtaining a usable biodiesel (e.g., a fuel usable as an alternative to oil, oil derivatives, and other fossil fuels) from a crude biodiesel product, the crude biodiesel product must be treated, such as by the addition of acid to reduce the pH, heating, mixing, and phase separation, followed by the addition of pH adjusting components and water content and/or viscosity-adjusting components to the separated portions. However, embodiments usable within the scope of the present disclosure can include an emulsion base that includes a substantially unmodified crude biodiesel product. A crude biodiesel product, without modification or separation, includes a continuous oil phase (e.g., alkyl ester or a similar oleaginous component) and a discontinuous phase (e.g., glycerin, polyglycerin, and/or water). The presence of other waste products (e.g., fiber, salts of fatty acids, etc.) will generally not affect the utility of the crude biodiesel product as an emulsion base, and may in fact improve this functionality (e.g., via interaction at the interface between the continuous and discontinuous phases).

Therefore, in an embodiment, the emulsion base includes a crude biodiesel product containing a continuous/oleaginous phase (e.g., alkyl ester) and a discontinuous phase (e.g., glycerin), without requiring any substantial modification and/or processing. A crude biodiesel product can be readily obtained from any number of facilities associated with the production of biodiesel products, such as diesel fuel, and such crude biodiesel products are available in abundance. Further, use of crude biodiesel products as an emulsion base eliminates the need to separately dispose of the waste portion of the crude biodiesel products, while enabling embodiments of the present emulsion to be produced using generally renewable products (e.g., plant or animal products), without requiring significant consumption or use of petrochemicals.

Additionally, use of a crude biodiesel product as an emulsion base, which can include glycerin or a similar compound as the discontinuous phase, enables the resulting emulsion to be used as an effective drilling mud/fluid that does not include and/or require a significant quantity of water and does not require the production or inclusion of brine or similar salts (e.g., calcium chloride, potassium chloride, sodium chloride, magnesium sulfate, potassium acetate or formate, etc.) and/or ionic components. Use of glycerin or a similar compound can provide the resulting emulsion with functionality and effectiveness as a drilling mud equal to or exceeding that of conventional invert emulsions, while avoiding the drawbacks inherent in the use of water and brines, such as swelling, formation damage, and negative environmental impact.

Similarly, use of a crude biodiesel product as an emulsion base, which can include alkyl ester as the continuous phase, enables the resulting emulsion to be used as an effective drilling mud/fluid that does not include and/or require a significant quantity of aromatics or similar toxic, hydrocarbon-based chemicals. Esters biodegrade at environmentally acceptable rates and are generally non-toxic, while exhibiting similar effectiveness to emulsions containing aromatics.

As described above, an emulsifying subsystem can be added to the emulsion base to facilitate the stability thereof. While any type of emulsifier can be used without departing from the scope of the present disclosure, in an embodiment, the emulsifying subsystem can include solid particles having a tendency to be anchored and/or otherwise retained at interfaces between the continuous component and discontinuous component of the emulsion base. As such, use of an emulsifying subsystem containing solid particles (e.g., forming a solid-stabilized emulsion) can allow embodiments of the present emulsion to include no conventional organic surfactants, significantly improving the environmental impact thereof. Additionally, emulsions stabilized by solid particles (e.g., hydrophobic silica particles) have been shown to exhibit equal or superior stability when compared to emulsions stabilized using conventional emulsifiers (e.g., sorbitan monooleate emulsifier). In use, solid particles can form a three-dimensional network in the continuous phase of an emulsion to prevent sedimentation and/or can form a steric barrier between droplets of discontinuous phase to prevent coalescence between droplets of the discontinuous phase. Solid particles can thereby effectively serve as a mechanical barrier that resists and/or prevents coalescence of the discontinuous phase and/or separation of the emulsion components.

In an embodiment, solid particles of the emulsifying subsystem can be produced by organophilization, thereby activating the solids to be drawn to the interface between the continuous (e.g., alkly ester) and discontinuous (e.g., glycerin) components of the emulsion base, to define and maintain the continuous and discontinuous phases within the emulsion. For example, in one possible embodiment, an unmodified phyllosilicate (e.g., a smectite and/or montmorillonite clay, such as bentonite, hectorite, and/or saponite), and a quaternary ammonium compound, or a similar chemical capable of ionic exchange, can both be added to the emulsion base, where the quaternary ammonium compound and unmodified phylosilicate will interact in situ (e.g., within the emulsion base) to form an organophilic component that will migrate to the interface between the continuous and discontinuous components of the emulsion base. In an embodiment, the phylosilicate can include a smectite clay having a cation exchange capacity of 75 milliequivalents per 100 grams of smectite clay, or greater.

It should be understood, however, that the addition of multiple components that react in situ to form an organophilic component is an exemplary embodiment, and that the addition of a prepared organophilic and/or hydrophobic, lipophilic, hydrophilic, and/or amphiphilic component to the emulsion base can be undertaken without departing from the scope of the present disclosure.

Use of an emulsifying subsystem that includes solid particles at the interface between discontinuous and continuous components of the emulsion base can eliminate the need for conventional organic surfactants and similar compounds that create disposal issues and produce a significant negative environmental impact. In embodiments where a smectite clay or similar, generally environmentally-friendly solid component is used, the environmental impact of the emulsifying subsystem can be significantly reduced, if not eliminated.

While the addition of other additives to the emulsion base may generally be unnecessary, in various embodiments, shale stabilizers, filtration control additives, suspending agents, dispersants, thinners, anti-balling additives, lubricants, seepage control additives, lost circulation additives, drilling enhancers, penetration rate enhancers, corrosion inhibitors, acids, bases, buffers, scavengers, gelling agents, cross-linkers, catalysts, soluble salts, biocides, bridging agents, rheology-modifying agents, viscosity-modifying agents, and/or combinations thereof could be added without departing from the scope of the present disclosure.

In embodiments where a prepared emulsion is to be used as a drilling mud, one or more weighting agents (e.g., barite, hematite, and/or other weighting agents) can be added to the emulsion base and emulsifying subsystem. The amount of weighting agent added can be varied depending on the desired mud weight (e.g., specific gravity) of the resulting emulsion, which can depend on the conditions of a particular wellbore and/or formation.

When used in formations having extremely high temperatures (e.g., in excess of 300 degrees Fahrenheit (150 degrees Centigrade)), a rheology modifying agent, such as an organic derivative of a clay (e.g., Bentone® 38) can be added to reduce and/or prevent drops in emulsion/electric stability and filtrate increases that may be expected by a decrease in the rheological properties of the emulsion expected at such temperatures. However, it should be understood that in many embodiments, use of rheology modifying agents may be unnecessary, and embodied emulsions may be stable at temperatures equal to or exceeding 300 degrees Fahrenheit (150 degrees Centigrade).

Table 1, below, describes an exemplary embodiment of an emulsion usable within the scope of the present disclosure.

TABLE 1

| COMPONENT | QUANTITY | |
|---|---|---|
| Emulsion Base (crude biodiesel product | 290 | milliliters |
| produced through the reaction of an un- | | |
| refinated and refinated soybean oil and | | |
| 2-ethyl-hexanol (iso-octyl alcohol)) | | |
| Emulsifying Subsystem | 30 | grams |
| Weighting Agent (barite) | 200 | grams |
| Total Volume | 350 | milliliters |

Specifically, Table 1, above, describes the contents of one barrel equivalent (350 ml) of an exemplary embodiment of an emulsion usable within the scope of the present disclosure. To 290 milliliters of an emulsion base that includes a crude biodiesel product, produced by the trans-esterificationreaction of an un-refinated and refinated soybean oil with 2-ethyl-hexanol (iso-octyl alcohol), an emulsifying subsystem can be added, which can include an organophilic clay (such as a mixture of a smectite clay with a quaternary ammonium compound, as described above). The resulting emulsion thereby includes a concentration of about 30 pounds per barrel of the emulsifying subsystem. A sufficient quantity of barite (a weighting agent), specifically, 200 grams, was added to bring the mud weight of the exemplary emulsion to 1.5 gr/cm̂3 (12.5 ppg).

Table 2, below, describes the measured rheology of the exemplary emulsion prepared by combining the contents described in Table 1. Specifically, Table 2 notes the measured rheology parameter (at 120 degrees Fahrenheit (50 degrees Centigrade) at various revolutions per minute (ranging from 3 rpm to 600 rpm), as well as the plastic viscosity, yield point, and gel strength of the exemplary emulsion. Measurements for each reading are provided before hot rolling of the exemplary emulsion, after hot rolling at 150 degrees Fahrenheit (65.5 degrees Centigrade) for 16 hours, and after hot rolling at 220 degrees Fahrenheit (105 degrees Centigrade) for 16 hours.

TABLE 2

| | | AFTER HOT | AFTER HOT |
|---|---|---|---|
| | | ROLLING (at 150 | ROLLING (at 220 |
| PARAMETER (at | | degrees F. (65.5 | degrees F. (105 |
| 120 degrees F. | BEFORE HOT | degrees C.) for 16 | degrees C.) for 15 |
| (50 degrees C.) | ROLLING | hours) | hours) |
| Rheology @ 600 | 100 | 104 | 109 |
| rpm (lbf/100 ft\hat{ }2) | | | |
| Rheology @ 300 | 60 | 67 | 64 |
| rpm (lbf/100 ft\hat{ }2) | | | |
| Rheology @ 200 | 30 | 31 | 29 |
| rpm (lbf/100 ft\hat{ }2) | | | |
| Rheology @ 100 | 21 | 23 | 20 |
| rpm (lbf/100 ft\hat{ }2) | | | |
| Rheology @ 6 rpm | 12 | 10 | 9 |
| (lbf/100 ft\hat{ }2) | | | |
| Rheology @ 3 rpm | 9 | 9 | 7 |
| (lbf/100 ft\hat{ }2) | | | |
| Plastic Viscosity | 40 | 37 | 45 |
| (cps) | | | |
| Yield Point | 20 | 30 | 19 |
| (lbf/100 ft\hat{ }2) | | | |
| Gel Strength | 10/14 | 10/12 | 8/10 |
| (lbf/100 ft\hat{ }2) | | | |

Table 3, below, describes the measured emulsion stability, high pressure-high temperature filtrate, and quantity of water measured in the exemplary emulsion.

TABLE 3

| | | AFTER HOT | AFTER HOT |
|---|---|---|---|
| | | ROLLING (at 150 | ROLLING (at 220 |
| | | degrees F. (65.5 | degrees F. (105 |
| | BEFORE HOT | degrees C.) for 16 | degrees C.) for 15 |
| PARAMETER | ROLLING | hours) | hours) |
| Emulsion Stability | Greater than 2000 | Greater than 2000 | Greater than 2000 |
| (V) | | | |
| HPHT Filtrate @ | 6.0 | 4.8 | 8.0 |
| 300 degrees | | | |
| Fahrenheit (150 | | | |
| degrees | | | |
| Centigrade), dP | | | |
| 500 psi (ml/30 min) | | | |
| Water in Filtrate (ml) | 0 | 0 | 0 |

After hot rolling the sample at 300 degrees Fahrenheit (approximately 150 degrees Centigrade) for a period of sixteen hours, a drop in the rheology properties of the emulsion was noted, as was a decrease in the emulsion stability and an increase in the filtrate. A concentration of 6 pounds per barrel of Bentone® 38 (an organic derivative of a clay) was added, and the exemplary emulsion was hot rolled again at 300 degrees Fahrenheit approximately 150 degrees Centigrade) for sixteen hours. Table 4 describes the measured rheology of the exemplary emulsion after the first period of hot rolling, before the addition of the Bentone® 38, and the measured rheology after the addition of the Bentone® 38 at a concentration of 6 ppb. Specifically, Table 4 notes the measured rheology parameter at various revolutions per minute (ranging from 3 rpm to 600 rpm), as well as the plastic viscosity, yield point, gel strength, emulsion stability, and HTHP filtrate measurement of the exemplary emulsion, both before and after the addition of the Bentone® 38.

TABLE 4

| | AFTER HOT | AFTER HOT |
|---|---|---|
| | ROLLING | ROLLING |
| | (before addition of | (after addition of 6 ppb |
| PARAMETER | Bentone ® 38) | Bentone ® 38 |
| Rheology @ 600 rpm | 49 | 110 |
| (lbf/100 ft\hat{ }2) | | |
| Rheology @ 300 rpm | 27 | 65 |
| (lbf/100 ft\hat{ }2) | | |
| Rheology @ 200 rpm | 15 | 29 |
| (lbf/100 ft\hat{ }2) | | |
| Rheology @ 100 rpm | 8 | 18 |
| (lbf/100 ft\hat{ }2) | | |
| Rheology @ 6 rpm | 4 | 12 |
| (lbf/100 ft\hat{ }2) | | |
| Rheology @ 3 rpm | 2 | 9 |
| (lbf/100 ft\hat{ }2) | | |
| Plastic Viscosity (cps) | 22 | 45 |
| Yield Point | 5 | 20 |
| (lbf/100 ft\hat{ }2) | | |
| Gel Strength | 2/3 | 8/11 |
| (lbf/100 ft\hat{ }2) | | |
| Emulsion Stability (V) | 1350 | 1790 |
| HTHP Filtrate | 12 | 8.8 |
| (at 300 degrees F. | | |
| (150 degrees C.), | | |
| dP 500 psi | | |
| (ml/30 min) | | |

Embodiments usable within the scope of the present disclosure thereby provide emulsions and methods of preparation and/or manufacture thereof, that are environmentally-friendly, can wholly replace use of conventional external emulsion phases (e.g., diesel, mineral oil, synthetic oil) through use of a transester, and can wholly replace use of brines with polyols. Further, the preparation of such emulsions can be reduced to 2-3 steps through use of crude biodiesel products as an emulsion base and/or in situ preparation of emulsifying subsystems. Exemplary samples of such emulsions were shown to be stable at temperatures of 220 degrees Fahrenheit (approximately 105 degrees Centigrade), or more, and at higher temperatures (e.g., 300 degrees Fahrenheit (about 150 degrees Centigrade)), the addition of Bentone® 38 or a similar substance can improve the rheological properties, stability, and filtrate of the emulsion. Embodiments of the present emulsion, however, can be stable at higher temperatures without the addition of such components, depending on the contents and properties thereof. Additionally, embodied emulsions can contain little to no water. Thus, even at higher filtrates, the polyol or other internal phase that would contact the formation will not promote borehole instability.

While these embodiments have been described with emphasis on the embodiments, it should be understood that within the scope of the appended claims, the embodiments might be practiced other than as specifically described herein.

What is claimed is:

1. A method for preparing an emulsion usable within a wellbore, the method comprising the steps of:
providing an emulsion base comprising a crude biodiesel product, wherein the crude biodiesel product comprises a continuous component and a discontinuous component; and
adding an emulsifying subsystem comprising solid particles to the emulsion base, wherein the solid particles migrate to interfaces between the continuous component and the discontinuous component, thereby resisting separation of the discontinuous component from the continuous component and defining a continuous phase and a discontinuous phase within the emulsion.

2. The method of claim 1, further comprising the step of adding a weighting agent to the emulsion base for providing the emulsion with a weight adapted for use as a drilling mud within the wellbore.

3. The method of claim 1, wherein the crude biodiesel product comprises a substantially unmodified compound produced through the trans-esterification of an oil with an alcohol using alkaline catalysts.

4. The method of claim 3, wherein the crude biodiesel product comprises a substantially unmodified compound produced through the trans-esterification of a vegetable oil with a low molecular weight alcohol.

5. The method of claim 4, wherein the crude biodiesel product comprises a substantially unmodified compound produced through the trans-esterification of soybean oil with 2-ethyl hexanol.

6. The method of claim 1, wherein the continuous component comprises an ester and the discontinuous component comprises a glycerin, a polyglycerin derivative, or combinations thereof.

7. The method of claim 6, wherein the continuous component comprises an alkyl ester.

8. The method of claim 1, wherein the step of adding the emulsifying subsystem to the emulsion base comprises adding an unmodified phyllosilicate and a quaternary ammonium compound to the emulsion base, and wherein the unmodified phyllosilicate and the quaternary ammonium compound interact in situ to form an organophilic component.

9. The method of claim 8, wherein the unmodified phyllosilicate comprises a smectite clay.

10. The method of claim 9, wherein the smectite clay comprises a cation exchange capacity of 75 milliequivalents per 100 grams of smectite clay, or greater.

11. The method of claim 10, wherein the smectite clay comprises bentonite, hectorite, saponite, or combinations thereof.

12. The method of claim 1, further comprising the step of adding a rheology modifier comprising an organic derivative of a clay to the emulsion base to improve stability of the emulsion at high temperatures.

13. The method of claim 1, wherein the emulsifying subsystem comprises a concentration ranging from twenty pounds per barrel to forty pounds per barrel.

14. The method of claim 13, wherein the emulsifying subsystem comprises a concentration of about thirty pounds per barrel.

15. An emulsion usable within a wellbore, the emulsion comprising:
an emulsion base comprising a crude biodiesel product, wherein the crude biodiesel product comprises a continuous component and a discontinuous component; and
an emulsifying subsystem comprising solid particles at the interfaces between the continuous component and the discontinuous component, thereby resisting separation of the discontinuous component from the continuous component and defining a continuous phase and a discontinuous phase within the emulsion.

16. The emulsion of claim 15, further comprising a weighting agent for providing the emulsion with a weight adapted for use as a drilling mud within the wellbore.

17. The emulsion of claim 15, wherein the crude biodiesel product comprises a substantially unmodified compound produced through the trans-esterification of an oil with an alcohol using alkaline catalysts.

18. The emulsion of claim 17, wherein the crude biodiesel product comprises a substantially unmodified compound produced through the trans-esterification of a vegetable oil with a low molecular weight alcohol.

19. The emulsion of claim 18, wherein the crude biodiesel product comprises a substantially unmodified compound produced through the trans-esterification of soybean oil with 2-ethyl hexanol.

20. The emulsion of claim 17, wherein the continuous component comprises an ester and the discontinuous component comprises a glycerin, a polyglycerin derivative, or combinations thereof.

21. The emulsion of claim 20, wherein the continuous component comprises an alkyl ester.

22. The emulsion of claim 15, wherein the emulsifying subsystem comprises an organophilic component produced by adding an unmodified phyllosilicate and a quaternary ammonium compound to the emulsion base.

23. The emulsion of claim 22, wherein the unmodified phyllosilicate comprises a smectite clay.

24. The emulsion of claim 23, wherein the smectite clay comprises a cation exchange capacity of 75 milliequivalents per 100 grams of smectite clay, or greater.

25. The emulsion of claim 24, wherein the smectite clay comprises bentonite, hectorite, saponite, or combinations thereof.

26. The emulsion of claim 15, further comprising a rheology modifier comprising an organic derivative of a clay for improving stability of the emulsion at high temperatures.

27. The emulsion of claim 15, wherein the emulsifying subsystem comprises a concentration ranging from twenty pounds per barrel to forty pounds per barrel.

28. The emulsion of claim 27, wherein the emulsifying subsystem comprises a concentration of about thirty pounds per barrel.

29. A method for preparing an emulsion usable as a drilling fluid within a wellbore, the method comprising the steps of:
providing a substantially unmodified crude biodiesel product produced through the trans-esterification of an oil with an alcohol, wherein the substantially unmodified crude biodiesel product comprises an alkyl ester and a glycerin;
adding an unmodified phyllosilicate and a quaternary ammonium compound to the substantially unmodified crude biodiesel product, wherein the unmodified phyllosilicate and the quaternary ammonium compound interact in situ to form an organophilic component, and wherein the organophilic component migrates to interfaces between the alkyl ester and the glycerin, thereby resisting separation of the glycerin from the alkyl ester and defining a continuous phase of alkyl ester and a discontinuous phase of glycerin within the emulsion; and
adding a weighting agent to the substantially unmodified crude biodiesel product for providing the emulsion with a weight adapted for use within the wellbore.

30. The method of claim 29, wherein the unmodified phyllosilicate comprises a smectite clay having a cation exchange capacity of 75 milliequivalents per 100 grams of smectite clay, or greater.

31. The method of claim 29, further comprising the step of adding a rheology modifier comprising an organic derivative of a clay to the substantially unmodified crude biodiesel product to improve stability of the emulsion at high temperatures.

32. The method of claim 29, wherein the organophilic component comprises a concentration of about thirty pounds per barrel.
